(19) United States
(12) Patent Application Publication
(10) Pub. No.: US 2009/0228523 A1
(43) Pub. Date: Sep. 10, 2009

(54) STORAGE INTEGRATION APPARATUS, STORAGE INTEGRATION PROGRAM, AND STORAGE INTEGRATION METHOD

(75) Inventor: Masazumi Matsubara, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/366,509

(22) Filed: Feb. 5, 2009

(30) Foreign Application Priority Data
Mar. 10, 2008 (JP) 2008-059043

(51) Int. Cl. G06F 12/00; G06F 17/30

(52) U.S. Cl. 707/200; 707/E17.044; 711/E12.001

(57) ABSTRACT

A storage integration apparatus includes a replacement unit which obtains relationship information indicating relationships among pieces of data and replaces requested data, which is data that has been requested, with different data that is different from the requested data in accordance with the relationship information, a selection unit which selects, from among at least one storage unit, an obtaining site from which the different data is to be obtained, replacement having been performed with the different data by the replacement unit, an obtaining unit which obtains the different data from the obtaining site selected by the selection unit, and a generation unit which generates the requested data using the different data obtained by the obtaining unit and the relationship information

### CROSS-REFERENCE TO RELATED APPLICATIONS

This application is based upon and claims the benefit of priority of the prior Japanese Patent Application No. 2008-059043, filed on Mar. 10, 2008, the entire contents of which are incorporated herein by reference.

### FIELD

The embodiments discussed herein are related to data referencing in a distributed database environment.

### BACKGROUND

Technical research is being performed in the field of distributed databases, and as the complexity of information technology (IT) systems has increased in recent years, technologies for distributed databases are becoming used even in data coordination between software programs that perform the operation and management of such IT systems. However, the contents of and the structure of databases included in operation-and-management software programs of IT systems may be different in terms of the resource type and provider (vendor) of the operation-and-management software programs thereof.

Thus, there is a method in which a query is sent in accordance with a common schema, and data referencing is performed by converting the query into unique schemas each of which corresponds to one of the databases. Here, the common schema has been defined in advance, and information regarding databases of different types collected from clients (other operation-and-management software programs in many cases) is organized in the common schema.

On the other hand, as an example of technology related to databases, there is a method in which a replica database holding the same information as a master database is provided so that the fault tolerance against data loss and the like can be improved and the load distribution of databases can be realized.

### SUMMARY

According to an aspect of the invention, a storage integration apparatus includes a replacement unit which obtains relationship information indicating relationships among pieces of data and replaces requested data, which is data that has been requested, with different data that is different from the requested data in accordance with the relationship information, a selection unit which selects, from among at least one storage unit, an obtaining site from which the different data is to be obtained, replacement having been performed with the different data by the replacement unit, an obtaining unit which obtains the different data from the obtaining site selected by the selection unit, and a generation unit which generates the requested data using the different data obtained by the obtaining unit and the relationship information The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram showing an exemplary integrated database system according to an embodiment;

FIG. 2 is a diagram showing exemplary relationships among databases according to the embodiment;

FIG. 3 is a diagram showing an example of information items and values thereof held in an individual DB 120 according to the embodiment;

FIG. 4 is a diagram showing an example of information items and values thereof held in an individual DB 121 according to the embodiment;

FIG. 5 is a diagram showing an example of information items and values thereof held in an individual DB 122 according to the embodiment;

FIG. 6 is a diagram showing an exemplary common schema according to the embodiment;

FIG. 7 is a diagram showing exemplary data mapping information according to the embodiment;

FIG. 8 is a diagram showing an exemplary table containing data relationship information according to the embodiment;

FIG. 9 is a flowchart showing exemplary processing of the integrated database system according to the embodiment; and

FIG. 10 is a diagram showing an example of an average response time period for each of the individual DBs according to the embodiment.

### DESCRIPTION OF EMBODIMENTS

In the above-described method in which a replica database is provided, the more that data is duplexed by providing a plurality of replica databases, the more the capacity thereof is increased and the more the cost is increased. Moreover, as a matter of course, data which has not been registered in any of the databases cannot be obtained.

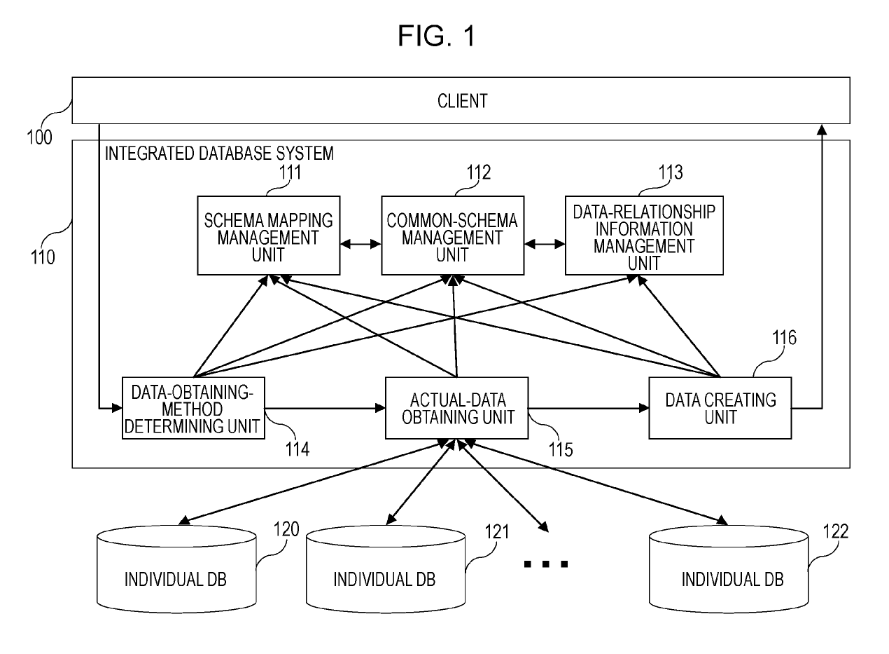

In the following, embodiments of the present invention will be described with reference to the attached drawings. First, FIG. 1 shows a functional block diagram of an integrated database system in the embodiment.

An integrated database system 110 (a storage integration apparatus) includes a schema mapping management unit 111, a common-schema management unit 112, a data-relationship information management unit 113, a data-obtaining-method determining unit 114, an actual-data obtaining unit 115, and a data creating unit 116.

The schema mapping management unit 111 manages correspondences among data schemas of the common schema and those of each of individual DBs.

The common-schema management unit 112 manages the common schema which has been defined by integrating data schemas for the individual DBs and made to be common for the individual DBs. Here, the individual DBs are targets to be integrated (an individual DB 120, an individual DB 121, and an individual DB 122 in FIG. 1) (storage units).

The data-relationship information management unit 113 holds data relationship information (relationship information) indicating relationships among pieces of data defined in the common schema. The data relationship information represents, in mathematical expressions and logical expressions, relationships among data which is from among data (entity) defined in the common schema and which can be derived from data that is different from requested data which has been requested by a client 100.

The data-obtaining-method determining unit 114 determines how data is to be obtained in response to a query request from the client 100.

The actual-data obtaining unit 115 actually obtains data from each of the individual DBs.

The data creating unit 116 creates (generates) requested data using one or more pieces of data obtained and the data relationship information.

When access is made from the client 100, with the consideration of the presence or absence of the data requested by the client 100 and the load information regarding databases in which data is held, the data-obtaining-method determining unit 114 determines whether to simply obtain the requested data from a database or to create (generate) the requested data from other data in accordance with the data relationship information held in the above-described data-relationship information management unit 113.

When it has been determined that the requested data is to be created (generated) from other data, the data-obtaining-method determining unit 114 determines other data necessary to derive target data by referring to the data relationship information held in the data-relationship information management unit 113. The actual-data obtaining unit 115 sends a subquery to the database which holds this other data and obtains this other data, similarly to a usual distributed database. Then, the data creating unit 116 derives the requested data from this obtained other data in accordance with the data relationship information. Then, the requested data derived is returned to the client 100.

Here, the integrated database system 110 is realized by causing hardware resources such as a central processing unit (CPU), a memory, and a hard disk drive (not shown) and software resources to cooperatively perform the above-described functions.

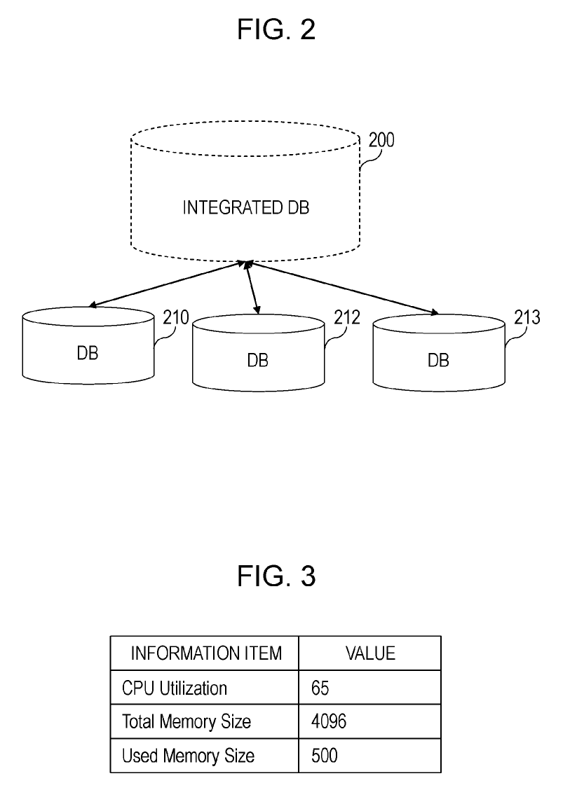

Next, FIG. 2 shows correspondences among databases in the embodiment. In the embodiment, an integrated DB 200 shown in FIG. 2 corresponds to the integrated database system 110. A DB 210, a DB 212, and a DB 213 correspond to the individual DB 120, the individual DB 121, and the individual DB 122 shown in FIG. 1, respectively.

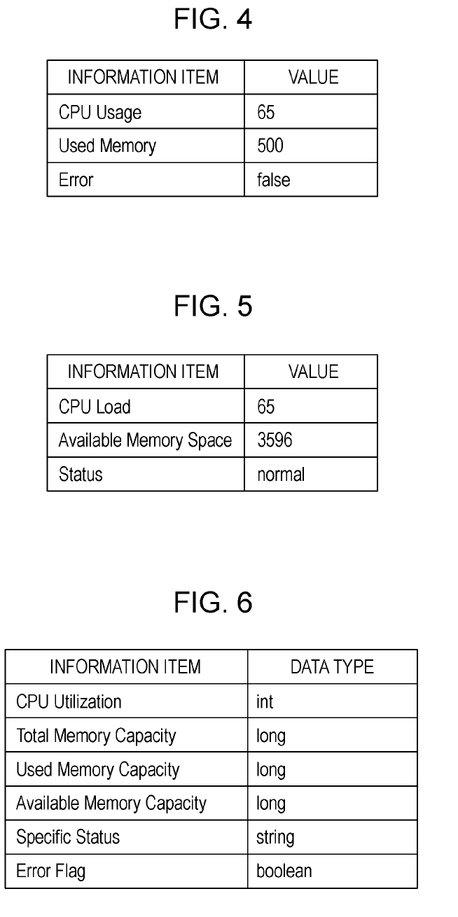

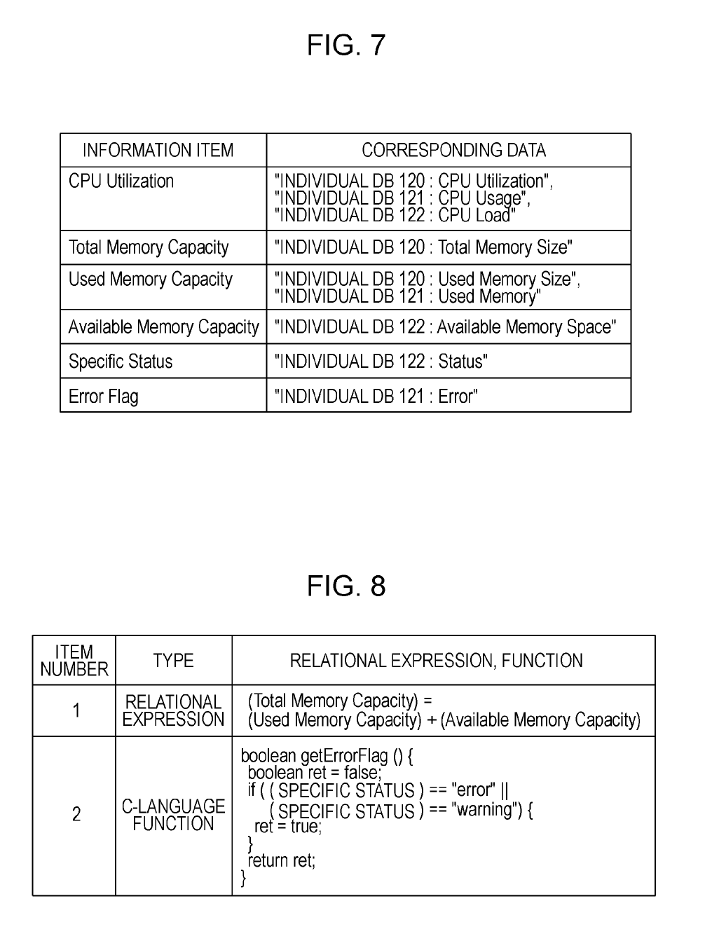

The individual DB 120, which is an individual DB, holds information items, “CPU Utilization”, “Total Memory Size”, and “Used Memory Size”, and values for the information items as shown in FIG. 3. The individual DB 121 holds information items, “CPU Usage”, “Used Memory”, and “Error”, and values for the information items as shown in FIG. 4. The individual DB 122 holds information items, “CPU Load”, “Available Memory Space”, and “Status”, and values for the information items as shown in FIG. 5. Moreover, the common-schema management unit 112 in the integrated database system 110 holds correspondences among information items defined in the common schema and data types thereof as shown in FIG. 6. Moreover, the schema mapping management unit 111 holds correspondences among the data schemas of the individual DBs and the data schemas of the common schema (hereinafter referred to as data mapping information) as shown in FIG. 7. For example, “CPU Utilization” is mapped to the “CPU Utilization” of the individual DB 120, the “CPU Usage” of the individual DB 121, and the “CPU Load” of the individual DB 122. “Total Memory Capacity” is mapped to the “Total Memory Size” of the individual DB 120. In the following, “Used Memory Capacity”, “Available Memory Capacity”, “Specific Status”, and “Error Flag” are similarly mapped to corresponding information items for the individual DBs.

Here, for brevity, flat data schemas are used in all cases; however, such flat data schemas may be in a table format, which general relational databases use, or the flat data schemas may be in an object tree format, which object databases or native extensible markup language (XML) databases use. Moreover, when the schema mapping is performed, not only synonyms are integrated as described in the embodiment but also a correspondence obtained after one-to-one data format conversion may be held.

The data-relationship information management unit 113 holds data correspondence information indicating relationships among pieces of data defined in the common schema as shown in FIG. 8, in a format of numerical expressions or functions using a predetermined programming language. The data-relationship information management unit 113 in this embodiment holds, for example, a table including “Item Number”, “Type” indicating types of relationship such as a relational expression and a C-language function, and “Relational Expression, Function” indicating details of a relationship; however, the relationships among pieces of data may be expressed in any way as long as they can be interpreted by the integrated database system 110.

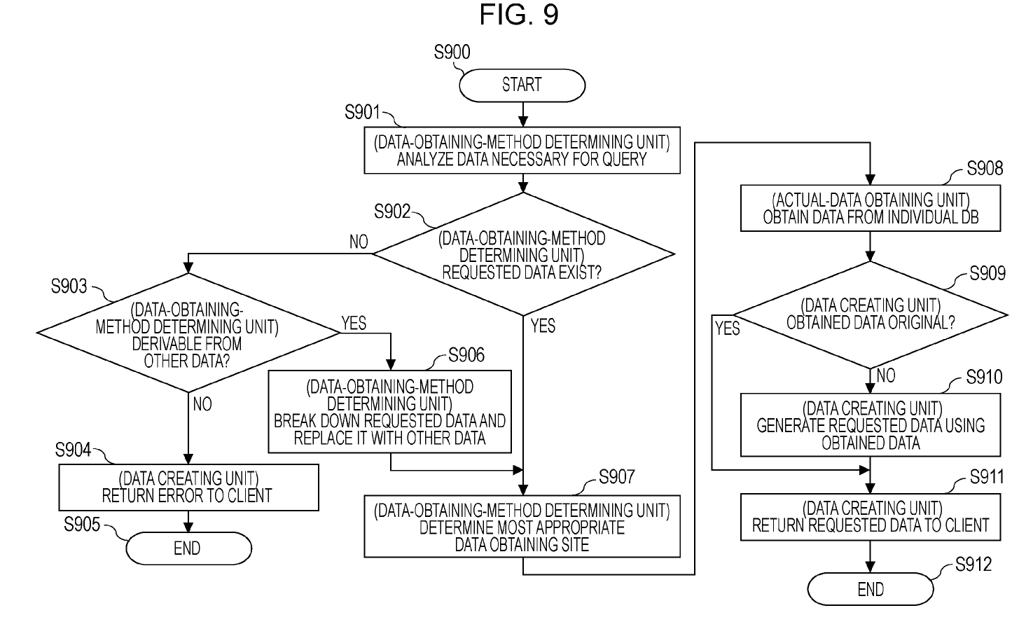

Next, the processing performed in the integrated database system 110 will be described with reference to a flowchart shown in FIG. 9. Here, in FIG. 9, functional blocks each of which executes one of the steps are shown in parentheses.

First, in step S901, the data-obtaining-method determining unit 114 analyzes a query received from the client 100 and extracts data that has been requested, data utilized to perform a search, or the like.

Next, in step S902, the data-obtaining-method determining unit 114 checks whether the extracted data (requested data) exists in one or more individual DBs (whether the extracted data (requested data) is obtainable) in accordance with the data mapping information (see FIG. 7) held in the schema mapping management unit 111.

If such data exists therein (“Yes” in step S902), the procedure proceeds to step S907. On the other hand, if such data does not exist therein (“No” in step S902), in step S903, the data-obtaining-method determining unit 114 determines whether the requested data which has been extracted by referring to the data relationship information (see FIG. 8) stored in the data-relationship information management unit 113 can be derived from other data.

If it has been determined that the requested data can be derived from other data (“Yes” in step S903), in step S906, the data-obtaining-method determining unit 114 obtains the data relationship information from the data-relationship information management unit 113, breaks down the requested data in accordance with the data relationship information, and replaces the requested data with other data, and the procedure proceeds to step S907. On the other hand, if it has been determined that the requested data cannot be derived from other data (“No” in step S903), in step S904, the data creating unit 116 returns an error to the client 100, and the procedure ends in step S905.

In step S907, according to some kind of standards, the data-obtaining-method determining unit 114 selects and obtains the most appropriate data obtaining site from which data is to be obtained as an obtaining site in a case in which there are a number of data obtaining methods which can be used, for example, the data to be obtained is redundantly held in a plurality of individual DBs or the data to be obtained can be derived from other data. Here, if there is only one data obtaining method, the data-obtaining-method determining unit 114 selects the method and the procedure proceeds to the next step.

When the data to be obtained is actually determined by the above-described processing performed by the data-obtaining-method determining unit 114, in step S908, the actual-data obtaining unit 115 makes an inquiry to a target individual DB (the obtaining site) and obtains the data. Thereafter, in step S909, the data creating unit 116 determines whether the data obtained by the actual-data obtaining unit 115 is the (original) requested data or other data derived, in accordance with the data mapping information (see FIG. 7) and the data relationship information (see FIG. 8).

If the obtained data is other data (“No” in step S909), in step S910, the data creating unit 116 collects the obtained data and creates (generates) the requested data requested by the client 100 in accordance with the data relationship information. Thereafter, in step S911, the data creating unit 116 returns the created data to the client 100, and the procedure ends in step S912.

On the other hand, if the obtained data is the requested data (“Yes” in step S909), in step S911, the data creating unit 116 simply returns the obtained data to the client 100, and the procedure ends in step S912.

Here, a simple pattern in which the data is directly returned to the client 100 is shown in the flowchart described above; however, if data necessary for evaluating conditions under which data is obtained is obtained, after appropriate matching processing is performed, the procedure may be repeated from step S902 in accordance with the result of the matching processing.

Next, the above-described processing will be further described by illustrating specific examples.

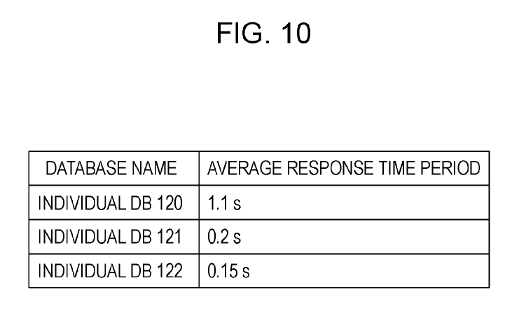

First, a specific processing operation will be described by taking a case in which a request for obtaining “Total Memory Capacity” is made by the client 100 as an example. Here, in step S907 in FIG. 9, it is assumed that a method capable of obtaining data in the shortest time period relative to the response time period from each of the individual DBs is selected. (Here, it is assumed that obtaining of data from each of the individual DBs can be performed in parallel and a data creation time period is not considered.) Moreover, it is assumed that an average response time period (load information) for accessing each of the individual DBs at the time a request is obtained is shown in FIG. 10.

In this case, according to the data mapping information (see FIG. 7), the “Total Memory Capacity” is held as the “Total Memory Size” in the individual DB 120. On the other hand, according to data relationship information item number 1 in the table (see FIG. 8) held in the data-relationship information management unit 113, the “Total Memory Capacity” can be calculated by adding the “Used Memory Capacity” and the “Available Memory Capacity”.

Furthermore, according to the data mapping information, it is apparent that the data corresponding to the “Used Memory Capacity” is held in the individual DB 120 (as the “Used Memory Size” in FIG. 3) and the individual DB 121 (as the “Used Memory” in FIG. 4), and that the data corresponding to the “Available Memory Capacity” is held in the individual DB 122 (as the “Available Memory Space” in FIG. 5).

The data-obtaining-method determining unit 114 detects that there are three choices, as shown below, before step S907 in accordance with the above-described information.

Obtain “Total Memory Size” from the individual DB 120.

Obtain “Used Memory Size” from the individual DB 120 and “Available Memory Space” from the individual DB 122, and combine them.

Obtain “Used Memory” from the individual DB 121 and “Available Memory Space” from the individual DB 122, and combine them.

Then, in step S907, the data-obtaining-method determining unit 114 determines that there is a light load for the individual DB 121 and the individual DB 122 (a response time period is not long) compared with the individual DB 120 by referring to the average response time period for each of the individual DBs shown in FIG. 10. The data-obtaining-method determining unit 114 selects the last one (“Obtain “Used Memory” from the individual DB 121 and “Available Memory Space” from the individual DB 122, and combine them.”) from among the above-described choices. Then, the actual-data obtaining unit 115 obtains various data from the individual DB 121 and the individual DB 122.

The data creating unit 116 obtains “Total Memory Capacity=4096” from the obtained values “Used Memory=500” and “Available Memory Space=3596” in accordance with the data relationship information item number 1 in the data relationship information (see FIG. 8), and returns the result to the client 100.

As a next specific example, a case will be described in which a request for obtaining “Error Flag” information is sent from the client 100 while the DB 212 (the individual DB 121 in FIG. 1) is out of order and cannot be accessed in FIG. 2.

In this case, as shown in the data mapping information of FIG. 7, the “Error Flag” information is only held by the out-of-order individual DB 121 (see the information item “Error” in FIG. 4). The data-obtaining-method determining unit 114 recognizes this fact by referring to the data mapping information in step S902. The data-obtaining-method determining unit 114 determines that the individual DB 121 is out of order (unavailable) in step S902, and the procedure proceeds to step S903. In step S903, the data-obtaining-method determining unit 114 determines whether the “Error Flag” information can be generated from other data. The data-obtaining-method determining unit 114 refers to data relationship information item number 2 in the table (see FIG. 8) held in the data-relationship information management unit 113 and determines that the “Error Flag” information can be derived from “Specific Status”.

Then, in step S906 and step S907, the data-obtaining-method determining unit 114 decides to make an inquiry to the individual DB 122, which is the only one to hold “Specific Status” information. Here, the “Specific Status” is mapped to the “Status” of the individual DB 122 according to the data mapping information in FIG. 7. The data-obtaining-method determining unit 114 decides to make an inquiry to the individual DB 122 according to this information.

The actual-data obtaining unit 115 obtains “Status” data from the individual DB 122, and thereafter the data creating unit 116 executes the data relationship information (item number 2 in the table shown in FIG. 8) and returns the result thereof “false” to the client 100.

The integrated database system 110 according to the embodiment can generate requested data from other data instead of directly obtaining the requested data, and thus a fault tolerance or load distribution function, which used to be achieved by using a replica server, can be realized at lower cost.

Moreover, the integrated database system 110 according to the embodiment can derive data from a relational expression defined with respect to the common schema, even if the data does not exist in an actual database, and thus the convenience of the whole distributed database is improved.

Here, a replacement unit, a selection unit, and a determining unit correspond to the data-obtaining-method determining unit 114 in the embodiment. Moreover, an obtaining unit corresponds to the actual-data obtaining unit 115 in the embodiment. Moreover, a generation unit corresponds to the data creating unit 116 in the embodiment.

Furthermore, a program causing a computer that constitutes the storage integration apparatus to execute the above-described steps can be provided as a storage integration program. The above-described program may be recorded on a computer-readable recording medium, whereby the computer that constitutes the storage integration apparatus can execute the above-described program. Here, examples of the computer-readable recording medium include internal storage installed inside of a computer, such as a read-only memory (ROM) and a random access memory (RAM), a portable recording medium such as a compact-disc read-only memory (CD-ROM), a flexible disk, a digital versatile disc (DVD), a magneto-optical disc, and an integrated circuit (IC) card.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A storage integration apparatus comprising:
a replacement unit which obtains relationship information indicating relationships among pieces of data and replaces requested data, which is data that has been requested, with different data that is different from the requested data in accordance with the relationship information;
a selection unit which selects, from among at least one storage unit, an obtaining site from which the different data is to be obtained, replacement having been performed with the different data by the replacement unit;
an obtaining unit which obtains the different data from the obtaining site selected by the selection unit; and
a generation unit which generates the requested data using the different data obtained by the obtaining unit and the relationship information.

2. The storage integration apparatus according to claim 1,
wherein, in a case in which there are a plurality of storage units, the selection unit selects the obtaining site from which the different data is to be obtained, in accordance with load information indicating the load of each of the storage units.

3. The storage integration apparatus according to claim 1,
wherein the relationship information is an expression for calculating the requested data from the different data.

4. The storage integration apparatus according to claim 1,
wherein the relationship information is indicated by a program written in a language interpretable by the storage integration apparatus.

5. The storage integration apparatus according to claim 1, further comprising:
a determining unit which determines whether the requested data is obtainable from the storage unit,
wherein the replacement unit replaces the requested data with the different data that is different from the requested data in a case in which the determination result of the determining unit indicates that the requested data is unobtainable.

6. The storage integration apparatus according to claim 5,
wherein, in a case the determining unit determines that the requested data is obtainable, the selection unit selects an obtaining site from which the requested data is to be obtained from among at least one storage unit, and
the obtaining unit further obtains the requested data from the obtaining site selected by the selection unit.

7. A computer readable recording medium recording a storage integration program causes a computer to execute a process comprising:
replacing requested data with different data that is different from the requested data in accordance with relationship information indicating relationships among pieces of data;
selecting, from among at least one storage unit, an obtaining site from which the different data is to be obtained;
obtaining the different data from the obtaining site; and
generating the requested data using the different data and the relationship information.

8. The computer readable recording medium recording a storage integration program according to claim 7,
wherein, the selecting , in a case in which there are a plurality of storage units, selects the obtaining site from which the different data is to be obtained in accordance with load information indicating the load of each of the storage units.

9. The computer readable recording medium recording a storage integration program according to claim 7,
wherein the relationship information is an expression for calculating the requested data from the different data.

10. The computer readable recording medium recording a storage integration program according to claim 7,
wherein the relationship information is information indicated by a program written in a language interpretable by the computer.

11. The computer readable recording medium recording a storage integration program according to claim 7,
further determining whether the requested data is obtainable from the storage unit, wherein
the replacing replaces, in a case in which the determination result indicates that the requested data is unobtainable, the requested data with the different data that is different from the requested data.

12. The computer readable recording medium recording a storage integration program according to claim 11,
wherein, the selecting selects, in a case in which it is determined that the requested data is obtainable, an obtaining site from which the requested data is to be obtained from among at least one storage unit, and
the obtaining obtains, the requested data from the selected obtaining site.

13. A storage integration method comprising:
replacing requested data, which is data that has been requested, with different data that is different from the requested data in accordance with relationship information indicating relationships among pieces of data;
selecting, from among at least one storage unit, an obtaining site from which the different data is to be obtained, replacement having been performed with the different data;
obtaining the different data from the selected obtaining site; and
generating the requested data using the obtained different data and the relationship information.

14. The storage integration method according to claim 13,
wherein, when the selection is performed, in a case in which there are a plurality of storage units, the obtaining site from which the different data is to be obtained is selected in accordance with load information indicating the load of each of the storage units.

15. The storage integration method according to claim 13,
wherein the relationship information is an expression for calculating the requested data from the different data.

16. The storage integration method according to claim 13,
wherein the relationship information is information indicated by a program written in a language interpretable by a computer capable of executing the storage integration method.

17. The storage integration method according to claim 13,
wherein it is further determined whether the requested data is obtainable from the storage unit, and
when the replacement is performed, in a case in which the determination result in the step of determining indicates that the requested data is unobtainable, the requested data is replaced with the different data that is different from the requested data.

18. The storage integration method according to claim 17,
wherein, when the selection is performed, in a case in which it is determined that the requested data is obtainable, an obtaining site from which the requested data is to be obtained is selected from among at least one storage unit, and
when the obtainment is performed, the requested data is further obtained from the selected obtaining site.
